(19) United States
(12) Patent Application Publication
(10) Pub. No.: US 2024/0054035 A1
(43) Pub. Date: Feb. 15, 2024

(54) DYNAMICALLY GENERATING APPLICATION PROGRAMMING INTERFACE (API) METHODS FOR EXECUTING NATURAL LANGUAGE INSTRUCTIONS

(71) Applicant: Pandravada Bhargav, Lake Tapps, WA (US)

(72) Inventor: Pandravada Bhargav, Lake Tapps, WA (US)

(21) Appl. No.: 18/234,352

(22) Filed: Aug. 15, 2023

Related U.S. Application Data
(60) Provisional application No. 63/398,154, filed on Aug. 15, 2022.

(51) Int. Cl. G06F 9/54

(52) U.S. Cl. CPC G06F 9/547

(57) ABSTRACT

Systems and methods for dynamically generating application programming interface (API) methods for executing natural language instructions. A system receives, from one or more source point associated with one or more user device, a set of natural language instructions for performing a task, processes, via a language model (LM) engine, the set of natural language instructions to generate one or more API methods to perform the task, generates, via one or more pathway builder engines, one or more pathways to one or more destination endpoints associated with one or more destination devices, and transmits one or more signals to each of the one or more destination endpoints to cause the corresponding one or more destination devices to execute the one or more API methods transmitted via said one or more signals, where the one or more signals include said API methods and a data structure having data required for execution thereof.

### CROSS-REFERENCE TO RELATED APPLICATIONS

This application claims the benefit under 35 U.S.C. § 119(e) of U.S. Provisional Patent Application No. 63/398,154, which was filed Aug. 15, 2022, and titled “DYNAMICALLY GENERATING APPLICATION PROGRAMMING INTERFACE (API) METHODS FOR EXECUTING NATURAL LANGUAGE INSTRUCTIONS,” which is hereby incorporated herein by reference in its entirety.

### BACKGROUND

Significant progress in development Artificial Intelligence (AI), has allowed language models such as Generative Pretrained Transformer 4 (GPT4), ChatGPT, Bidirectional Encoder Representations from Transformers (BERT), Sage, Claude and the like, find applications in tasks involving interpreting, generating, and performing tasks based on natural language commands. However, current generative AI models, among others, generate ‘best fit’ answers from pre-trained data and are limited to their respective training dataset. Generative AI models are also limited by their inability to execute code or instructions that they generate.

While AI models are capable of performing tasks across multiple endpoints, such as workflow automation AI, AI assistants, certain bots, Alexa etc., by being associated with a wrapper, such models are unable to act as a human agent with the ability to interact with a GUI or make estimates, optimizations, and simulations (visual, graphical or audio) like a rational person would across large systems like enterprises or factories Essentially, existing AI agents or intelligent agents are incapable of dynamically perceiving the environment, autonomously generating and executing actions to achieve a predefined goal, and learn from feedback obtained from execution of said actions. Furthermore, existing solutions are incapable for constructing dynamic AI agents that can generate API methods in novel situations for which said models are not necessarily trained for.

There is, therefore, a need for systems and methods for addressing at least the above-mentioned problems and gaps in existing systems.

### SUMMARY

This section is provided to introduce certain objects and aspects of the present disclosure in a simplified form that are further described below in the detailed description. This summary is not intended to identify the key features or the scope of the claimed subject matter.

In an aspect, the present disclosure relates to a system including a processor, and a memory operatively coupled with the processor, wherein the memory includes processor-executable instructions which, when executed by the processor, cause the processor to receive, from one or more source point associated with one or more user devices, a set of natural language instructions for performing a task, and process, via a language model (LM) engine, the set of natural language instructions to generate one or more application programming interface (API) methods to perform the task. The processor may generate, via one or more pathway builder engines, one or more pathways to one or more destination endpoints associated with one or more destination devices, and transmit one or more signals to each of the one or more destination endpoints to cause the corresponding one or more destination devices to execute the one or more API methods transmitted via said one or more signals, where the one or more signals comprises the one or more API methods and a data structure having data required for execution of said one or more API methods.

In an exemplary embodiment, the processor may receive, from the one or more destination endpoints, a response having an output generated on execution of the one or more API methods in the corresponding destination devices, and determine, using the LM engine, whether the output in the response corresponds to an expected output for the set of natural language instructions.

In an exemplary embodiment, the processor may train the LM engine with supervised and unsupervised machine learning techniques based on the response received from the destination endpoint, wherein the response comprises one or more attributes associated with an execution environment of the one or more destination devices in which the one or more API methods are executed, and where the LM engine is provided with a feedback during training by a heuristics engine that generates said feedback by comparing the one or more attributes with a predefined set of heuristics.

In an exemplary embodiment, the one or more destination devices is selected from a group including a software application on a computing device, a virtual machine, Internet of Things (IoT) device, autonomous robots, and industrial/commercial equipment.

In an exemplary embodiment, the one or more API methods are displayed on the user interface of the one or more user device, the one or more API methods being editable via the user interface.

In an exemplary embodiment, the processor may generate, via the pathway builder engine, one or more staging points associated with one or more intermediate processing engines configured to transform the data transmitted via the one or more signals, where the one or more staging points configured to receive the one or more signals from the one or more source points, process the data and the one or more API methods in the one or more signals, and transmit the processed data and the one API methods to the destination endpoints for execution.

In an exemplary embodiment, the one or more API methods may be either generated by the LM engine in real-time based on the set of natural language instructions, or retrieved from an API repository based on the set of natural language instructions, the API repository being periodically updated.

In an exemplary embodiment, each of the one or more source points and the one or more destination endpoints may be interconnected with each other by the one or more pathways such that said one or more source points receive and process the set of natural language instructions and transmit the set of signals to the one or more of the destination endpoints for executing the one or more API methods, where said one or more of the sources points may be configured to receive the set of natural language instructions from any one or combination of: the one or more user devices, the one or more source points, or the responses from one or more of the destination endpoints. In such embodiments, one or more of the destination endpoints may be configured to receive the set of signals from the one or more source points, said one or more of the destination endpoints being configured to execute the one or more API methods in the set of signals, and transmit the responses to one or more of the destination endpoints and the one or more source points.

In an exemplary embodiment, the one or more pathways may be ephemerally coupled such that the one or more pathways between the one or more source points and the one or more destination endpoints are generated and deleted based on satisfaction of one or more predefined constraints via the pathway builder engine.

In another aspect, the present disclosure relates to a computer-implemented method including receiving, by a processor of a system, from one or more source points associated with one or more user devices, a set of natural language instructions for performing a task, processing, via a language model (LM) engine of the system, the set of natural language instructions to generate one or more API methods to perform the task, generating, via one or more pathway builder engines of the system, one or more pathways to one or more destination endpoints associated with one or more destination devices, and transmitting, by the processor, one or more signals to each of the one or more destination endpoints to cause the corresponding one or more destination devices to execute the one or more API methods transmitted via said one or more signals, where the one or more signals comprises the one or more API methods and a data structure having data required for execution of the one or more API methods.

In an exemplary embodiment, the method includes receiving, by the processor, from the one or more destination endpoints, a response having an output generated on execution of the one or more API methods in the corresponding destination devices; and determining, by the processor, using the LM engine, whether the output in the response corresponds to an expected output for the set of natural language instructions.

In an exemplary embodiment, the method includes training, by the processor, the LM engine with supervised and unsupervised machine learning techniques based on the response received from the destination endpoint, wherein the response comprises one or more attributes associated with an execution environment of the one or more destination devices in which the one or more API methods are executed, and wherein the LM engine is provided with a feedback during training by a heuristics engine that generates said feedback by comparing the one or more attributes with a predefined set of heuristics.

In an exemplary embodiment, the one or more destination devices is selected from a group comprising a software application on a computing device, a virtual machine, Internet of Things (IoT) device, autonomous robots, and industrial/commercial equipment.

In an exemplary embodiment, the one or more API methods are displayed on a user interface of the one or more user devices, the one or more API methods being editable via the user interface.

In an exemplary embodiment, the method includes generating, via the pathway builder engine, one or more staging points associated with one or more intermediate processing engines configured to transform the data transmitted via the one or more signals, where the one or more staging points to configured to receive the one or more signals from the one or more source points, process the data and the one or more API methods in the one or more signals, and transmit the processed data and the one API methods to the destination endpoints for execution.

In an exemplary embodiment, the one or more API methods may be either generated by the LM engine in real-time based on the set of natural language instructions, or retrieved from an API repository based on the set of natural language instructions, the API repository being periodically updated.

In an exemplary embodiment, each of the one or more source points and the one or more destination endpoints may be interconnected with each other by the one or more pathways such that said one or more source points receive and process the set of natural language instructions and transmit the set of signals to the one or more of the destination endpoints for executing the one or more API methods, where said one or more of the sources points may be configured to receive the set of natural language instructions from any one or combination of: the one or more user devices, the one or more source points, or the responses from one or more of the destination endpoints. In such embodiments, one or more of the destination endpoints may be configured to receive the set of signals from the one or more source points, said one or more of the destination endpoints being configured to execute the one or more API methods in the set of signals, and transmit the responses to one or more of the destination endpoints and the one or more source points. In an exemplary embodiment, the one or more pathways may be ephemerally coupled such that the one or more pathways between the one or more source points and the one or more destination endpoints are generated and deleted based on satisfaction of one or more predefined constraints via the pathway builder engine.

In another aspect, the present disclosure relates to a non-transitory computer-readable medium comprising machine-readable instructions that are executable by a processor to perform the steps of the method described herein.

### BRIEF DESCRIPTION OF DRAWINGS

The accompanying drawings, which are incorporated herein, and constitute a part of this invention, illustrate exemplary embodiments of the disclosed methods and systems in which like reference numerals refer to the same parts throughout the different drawings. Components in the drawings are not necessarily to scale, emphasis instead being placed upon clearly illustrating the principles of the present invention. Some drawings may indicate the components using block diagrams and may not represent the internal circuitry of each component. It will be appreciated by those skilled in the art that invention of such drawings includes the invention of electrical components, electronic components or circuitry commonly used to implement such components.

FIG. 1 illustrates an exemplary network architecture in which a system for dynamically generating application programming interface (API) methods for executing natural language instructions, in accordance with embodiments of the present disclosure.

FIG. 2A-2B illustrates an exemplary block diagram of the proposed system for dynamically generating API methods for executing natural language instructions, in accordance with embodiments of the present disclosure.

FIG. 3A-3I illustrate exemplary implementations of the proposed system, in accordance with embodiments of the present disclosure.

FIG. 4 illustrates an exemplary flow chart of a method for dynamically generating API methods for executing natural language instructions, in accordance with embodiments of the present disclosure.

FIG. 5 illustrates a computer system in which or with which embodiments of the present disclosure may be implemented.

The foregoing shall be more apparent from the following more detailed description of the disclosure.

### DETAILED DESCRIPTION

In the following description, for the purposes of explanation, various specific details are set forth in order to provide a thorough understanding of embodiments of the present disclosure. It will be apparent, however, that embodiments of the present disclosure may be practiced without these specific details. Several features described hereafter can each be used independently of one another or with any combination of other features. An individual feature may not address all of the problems discussed above or might address only some of the problems discussed above. Some of the problems discussed above might not be fully addressed by any of the features described herein.

The ensuing description provides exemplary embodiments only, and is not intended to limit the scope, applicability, or configuration of the disclosure. Rather, the ensuing description of the exemplary embodiments will provide those skilled in the art with an enabling description for implementing an exemplary embodiment. It should be understood that various changes may be made in the function and arrangement of elements without departing from the scope of the invention as set forth.

Specific details are given in the following description to provide a thorough understanding of the embodiments. However, it will be understood by one of ordinary skill in the art that the embodiments may be practiced without these specific details. For example, circuits, systems, networks, processes, and other components may be shown as components in block diagram form in order not to obscure the embodiments in unnecessary detail. In other instances, well-known circuits, processes, algorithms, structures, and techniques may be shown without unnecessary detail in order to avoid obscuring the embodiments.

Also, it is noted that individual embodiments may be described as a process which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed but could have additional steps not included in a figure. A process may correspond to a method, a function, a procedure, a subroutine, a subprogram, etc. When a process corresponds to a function, its termination can correspond to a return of the function to the calling function or the main function.

The word “exemplary” and/or “demonstrative” is used herein to mean serving as an example, instance, or illustration. For the avoidance of doubt, the subject matter disclosed herein is not limited by such examples. In addition, any aspect or design described herein as “exemplary” and/or “demonstrative” is not necessarily to be construed as preferred or advantageous over other aspects or designs, nor is it meant to preclude equivalent exemplary structures and techniques known to those of ordinary skill in the art. Furthermore, to the extent that the terms “includes,” “has,” “contains,” and other similar words are used in either the detailed description or the claims, such terms are intended to be inclusive—in a manner similar to the term “comprising” as an open transition word—without precluding any additional or other elements.

Reference throughout this specification to “one embodiment” or “an embodiment” or “an instance” or “one instance” means that a particular feature, structure, or characteristic described in connection with the embodiment is included in at least one embodiment of the present disclosure. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

Existing attempts at building autonomous or agentic artificial intelligences have had limited success, despite advances in natural language processing, computer vision and robotics. Most solutions, after sensing and interpreting the environment, rely on either pre-programmed instructions to navigate the world and complete tasks, or provide limited capability for interacting with the environment. Exisitng solutions are limited to using known inter-process communication means to interact with the environment, which may not be flexible enough to allow for unexpected or unanticipated tasks, such as those in novel environments where there are no inter-process communication means available. In such situations, existing solutions are incapable of generating novels methods for communicating and interacting with the environment, and learning from past interactions, thereby being inherently incapable of bicameralism.

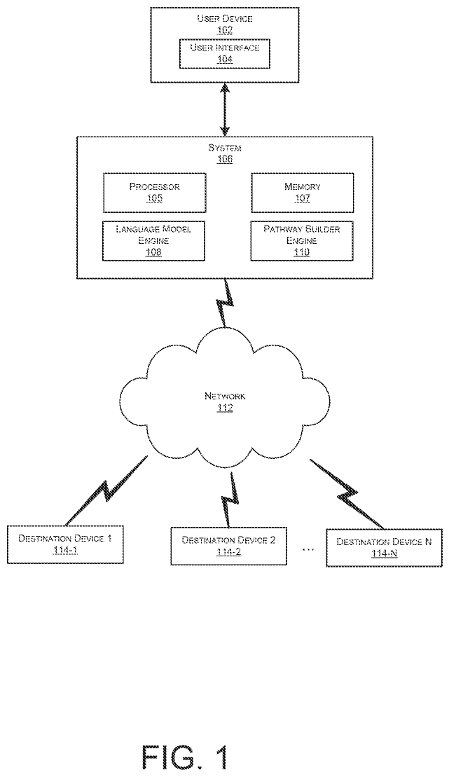

Accordingly, in order to overcome at least one of the aforementioned shortcomings of existing solutions, the present disclosure provides for a system that can dynamically generate API methods for natural language instructions, for interacting with the environment and learning from past interactions. The present disclosure provides for an agentic artificial intelligence (AI) system. In particular, the system may dynamically generate API methods for natural language instructions. The various embodiments throughout the disclosure will be explained in more detail with reference to FIGS. 1-5.

FIG. 1 illustrates an exemplary network architecture 100 in which a system 106 for dynamically generating application programming interface (API) methods for executing natural language instructions, in accordance with embodiments of the present disclosure.

In this embodiment, the network architecture 100 may include a system 106 including a processor 105, a memory 107, a language model (LM) engine 108 and a pathway builder engine 110. While the system 106 may include one or more LM engines 108 and one or more pathway builder engines 110, only one of each is shown in FIG. 1 for clarity. In embodiments shown in FIG. 1, the LM engine 108 and the pathway builder engine 110 may be embedded in the system 106. In other embodiments, the LM engine 108 and the pathway builder engine 110 may be external to the system 106, and may be communicatively coupled to said system 106. The system 106 may be configured to receive one or more natural language instructions from one or more user device 102 having a user interface 104. A user may use the user interface 104 for issuing the one or more natural language instructions.

In some embodiments, the processor 105 may be implemented as one or more microprocessors, microcomputers, microcontrollers, digital signal processors, central processing units, logic circuitries, and/or any devices that process data based on operational instructions. Among other capabilities, the processor 105 may be configured to fetch and execute computer-readable instructions stored in the memory 107 of the system 106. The memory 107 may be configured to store one or more computer-readable instructions or routines in a non-transitory computer readable storage medium, which may be fetched and executed to create or share data packets over a network service. The memory 107 may comprise any non-transitory storage device including, for example, volatile memory such as random-access memory (RAM), or non-volatile memory such as erasable programmable read only memory (EPROM), flash memory, and the like. The LM engine 108, the pathway builder engine 110, and other processing engines disclosed herein may be indicative of including, but not limited to, processors, such as processor 105, an Application-Specific Integrated Circuit (ASIC), an electronic circuit, and memory that execute one or more software or firmware programs, a combinational logic circuit, and/or other suitable components that provide the described functionality.

In some embodiments, the natural language instructions may be transmitted from the one or more user devices 102 to the system 106 via a network 112. The network 112 may include, by way of example, but not limited to, at least a portion of one or more networks having one or more nodes that transmit, receive, forward, generate, buffer, store, route, switch, process, or a combination thereof, etc. one or more messages, packets, signals, some combination thereof, or so forth. The network 112 may also include, by way of example, but not limited to, one or more of a wireless network, a wired network, an internet, an intranet, a public network, a private network, a packet-switched network, a circuit-switched network, an ad hoc network, an infrastructure network, a Public-Switched Telephone Network (PSTN), a cable network, a cellular network, a satellite network, a fibre optic network, or some combination thereof. In particular, the network 112 may be any network over which the user communicates with the system 106 using their respective computing devices.

The one or more user devices 102 may be indicative of a computing device. In an exemplary embodiment, the computing device may refer to a wireless device and/or a user equipment (UE). The computing device may include, but not be limited to, a handheld wireless communication device (e.g., a mobile phone, a smart phone, a phablet device, and so on), a wearable computer device (e.g., a head-mounted display computer device, a head-mounted camera device, a wristwatch computer device, and so on), a Global Positioning System (GPS) device, a laptop computer, a tablet computer, or another type of portable computer, a media playing device, a portable gaming system, and/or any other type of computer device with wireless communication capabilities, and the like. In some embodiments, the computing devices may include, but are not limited to, any electrical, electronic, electro-mechanical or an equipment or a combination of one or more of the above devices such as virtual reality (VR) devices, augmented reality (AR) devices, laptop, a general-purpose computer, desktop, personal digital assistant, tablet computer, mainframe computer, or any other computing device, wherein the computing device may include one or more in-built or externally coupled accessories including, but not limited to, a visual aid device such as camera, audio aid, a microphone, a keyboard, input devices for receiving input from the user such as touch pad, touch enabled screen, electronic pen and the like. A person of ordinary skill in the art will appreciate that the computing devices may not be restricted to the mentioned devices and various other devices may be used.

In some embodiments, the one or more user devices 102 may be coupled with an audio recording device, for example a microphone, but not limited thereto, that records the natural language instructions provided by the user through speech. In such embodiments, the one or more user devices 102 may record the user's natural language instructions via the audio recording device, and transmit the recording to the system 106. In some embodiments, the one or more user devices 102 may transcribe the audio to convert the natural language instructions to a textual representation. The one or more user devices 102 may use a speech-to-text engine to transcribe the recording. The one or more user devices 102 may then transmit said textual representation to the system 106. In other embodiments, the user may provide the natural language instructions in textual representations by inputting the said natural language instructions into the user interface 104 of the one or more user devices 102.

Referring to FIG. 1, the system 106 may be implemented by way of a single device or a combination of multiple devices that may be operatively connected or networked together. The system 106 may be implemented in a hardware or a suitable combination of hardware and software. In another exemplary embodiment, the system 106 may be implemented as a cloud computing device or any other device that is network connected. In another exemplary embodiment, the system 106 may be used in an on-premise environment. In an exemplary embodiment, the system 106 may implement the LM engines 108 and the pathway builder engines 110.

In accordance with embodiments of the present disclosure, the system 106 may dynamically generate API methods for execution of natural language instructions. Referring to FIG. 1, the user may use the one or more user device 102 to transmit a set of natural language instructions for performing a task, to the system 106. The system 106 may receive the set of natural language instructions and redirect the same to the LM engine 108. The LM engine 108 may process the set of natural language instructions to generate one or more API methods to perform the task. In some embodiments, the API methods may be indicative of signals transmitted to a path or a uniform resource locator (URL) address associated with the one or more destination devices 114, such that the one or more destination devices 114 executed a corresponding set of routines or sub-routines to perform a function. In some embodiments, the API methods may extract, transform or load data from the one or more destination devices 114. The API methods may allow for real-time augmentation, rendering, and modelling of data between the one or more sources endpoints and one or more destination endpoint.

In some embodiments, the LM engine 108 may be indicative of a probabilistic language model. In such embodiments, the LM engine 108 may include a set of weight values. In an example, the weight values may be indicative of float point numbers. In some embodiments, the set of weight values may include one or more subsets of weight values associated with a plurality of layers of a neural network. In some embodiments, the LM engine 108 may include a plurality of machine learning models. One or more of the pluralities of machine learning models may be configured to sequentially or parallelly so as to generate the one or more API method for executing the one or more natural language instructions. In some examples, the LM engine 108 may be configured to run large language models including, but not limited to, Generative Pretrained Transformers 4 (GPT 4), Llama 1, Llama 2, Claude, Vicuna, Alpaca, HuggingChat, Bloom, and the like. In other examples, the LM engine 108 may be configured to run custom pre-trained large language models. The LM engine 108 may be configured to execute large language models having at least greater than 1 billion parameters.

The LM engine 108 may be configured to receive the set of natural language instructions. The LM engine 108 may preprocess the set of natural language instructions by performing steps including, but not limited to, removal of stop words, tokenization, lexical disambiguation, text classification and the like. In embodiments where the LM engine 108 receives the natural language instructions as audio recordings, the LM engine 108 may transcribe the audio recording to convert the natural language instructions to textual representations. The LM engine 108 may then tokenize the set of natural language instructions to convert the set of natural language instructions to mathematical or processor-readable representations therefor. In some embodiments, one or more embeddings may be generated for the set of natural language instructions for processing by the large language models associated with the LM engine 108.

In some embodiments, the LM engine 108 may include one or more machine learning models that classify the set of natural language instructions to identify the type of executable actions required to perform the task. In some embodiments, the classification of the set of natural language instructions may also the LM engine 108 to determine whether the API methods are to be generated or retrieved from an API repository. In an example, if the set of natural language instructions relate to use of known API libraries, such as selenium, the LM engine 108 may retrieve the API methods associated with selenium that may be appropriate for the performance of the task. In other examples, if the set of natural language instructions relate to interaction with a GUI of an applications for which no API libraries exist, the LM engine 108 may generate the one or more API methods for the performance of the task.

In some embodiments, the LM engine 108 may be configured to generate text indicative of including, but not limited to, code, natural language, and/or a combination thereof. In some embodiments, the code generated by the LM engine 108 may be indicative of the one or more API methods.

In some embodiments, the LM engine 108 may be implemented using a library designed for building large language model-based autonomous agents, including LangChain, but not limited thereto. In such embodiments, the LM engine 108 may be configured to generate one or more processor-executable instructions and execute said instructions based on the natural language instructions. In an example, the LM engine 108 may be configured to scrap an e-commerce website to retrieve products along with their corresponding prices. In such examples, the LM engine 108 may take the user's natural language instructions as input and generate a set of processor-executable instructions, such as a python code that imports the requests library, and transmits a get request to the e-commerce website. The python code may then be executed in an environment. In such examples, the LM engine 108 may generate the one or more API methods, such as the python code of the foregoing example, but not limited thereto, based on the set of natural language instructions. The LM engine 108 may generate such API methods when an API for the e-commerce website is unavailable in an API repository, or is unavailable publicly.

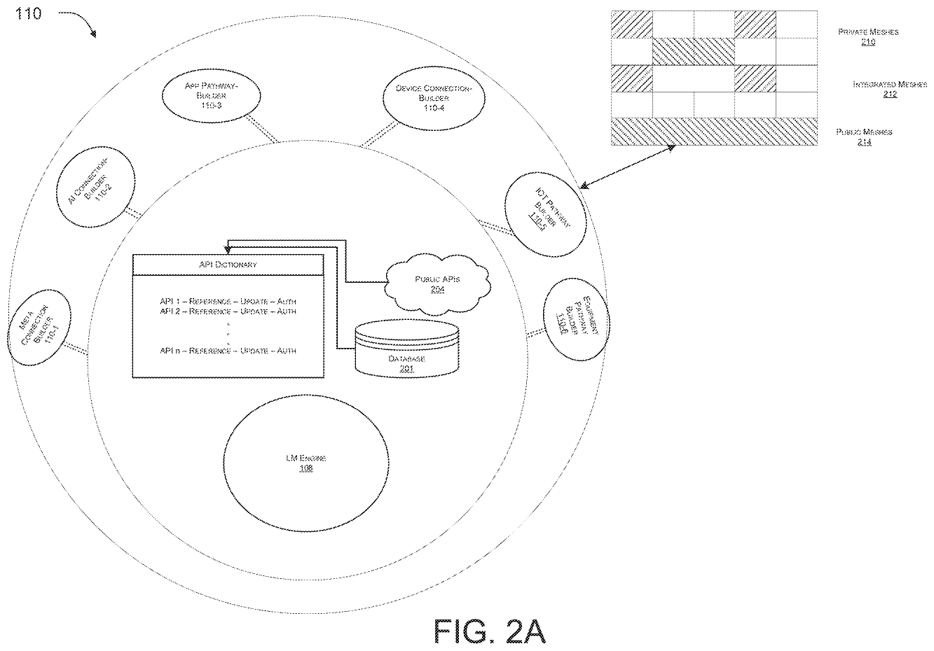

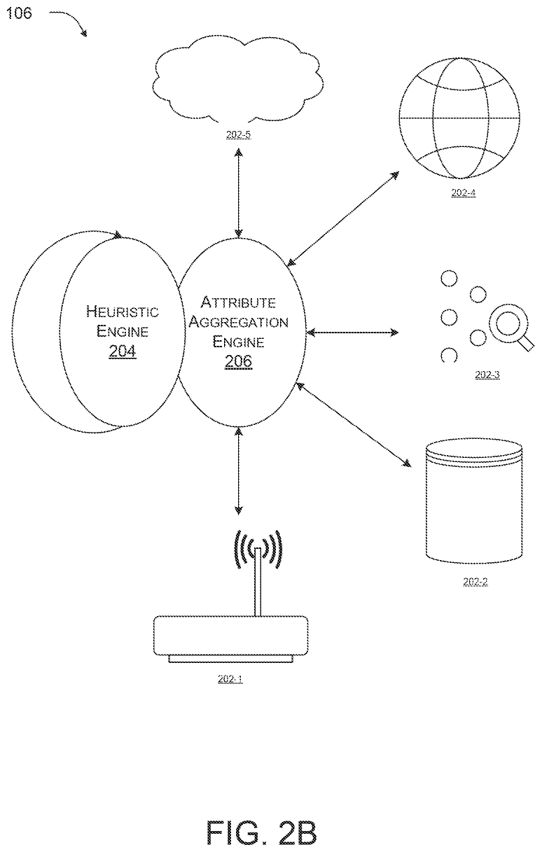

In other embodiments, the LM engine 108 may generate a natural language output having instructions, execution of which may allow for performance of the task stipulated in the set of natural language instructions. In such embodiments, the LM engine 108 may then retrieve the one or more API methods stored in an API repository indicative of a database 201 (shown in FIG. 2A). The LM engine 108 may interpret the set of natural language instructions, generate a task flow in natural language, and retrieve one or more of the API methods that correspond to each step in the generated task flow. In an embodiment, the API repository may be stored in an API dictionary having a plurality of key-value pairs. In some embodiments, the API repository may be periodically updated. In such embodiments, the system 106 may include a web-scrapper that periodically scrapes the web for new APIs and updates the API repository. Further, deprecated APIs in the API repository may be identified and deleted therefrom. In some embodiments, the API repository may also include authentication information required to execute the API methods.

In some embodiments, the pathway builder engine 110 may be configured to generate one or more pathways to one or more endpoints associated with one or more destination devices 114. The architecture 100 shows one or more destination devices such as destination device 1 114-1, destination device 2 114-2, . . . destination device N 114-N (collectively referred to as destination devices 114). In some embodiments, the destination devices 114 may include, but not be limited to, a software application on a computing device, a virtual machine, Internet of Things (IoT) device, autonomous robots and industrial/commercial equipment. The destination devices 114 may be implemented on including, but not limited to, smart phones, smart watches, smart sensors (e.g., mechanical, thermal, electrical, magnetic, etc.), networked appliances, networked peripheral devices, networked lighting system, communication devices, networked vehicle accessories, networked vehicular devices, smart accessories, tablets, smart television (TV), computers, smart security system, smart home system, other devices for monitoring or interacting with or for the users and/or entities, or any combination thereof. In other embodiments, the destination devices 114 may include, but not be limited to, one or more of the following devices: a web server, a database server, an application server, an enterprise server, a desktop computer, a laptop computer, a tablet computer, a web-enabled device, a network-enabled device, a mobile device, a telephone, a personal digital assistant (PDA), a smart phone, a wearable device, a gaming console, a set-top box, a television, a kiosk, a point-of-sale (POS) device, an Automated Teller Machines (ATM), an industrial controller, a medical device, an embedded device, an Internet of Things (IoT) device, a sensor, a smart meter, a camera, a robotic device, a vehicle, or any other type of device or machine.

In some embodiments, the destination devices 114 may have one or more destination endpoints associated therewith. The destination endpoints may allow the destination devices to form pathways to establish connection with the source points. The destination devices 114 may receive the one or more API methods therefrom. The destination devices 114 may be configured to execute one or more processor-executable instructions or routines or sub-routines on receiving the one or more API methods. The one or more API methods may be indicative of any indicative of one or more inter-process communication means. The inter-process communication means may include, but not be limited to, APIs, web hooks, message queues, webs sockets, remote procedure calls, Bluetooth/IoT communication protocols, command line interfaces (CLIs), and the like. It may be appreciated by those skilled in the art that the API methods may be suitably adapted or substituted with any of the one or more inter-process communication means without deviating from the scope of the present disclosure.

In some embodiments, the API methods may be received as a set of signals from the system 106. The set of signals may include a data structure having data required for execution of the one or more API methods. In some embodiments, the data structure may include one or more parameters required for the invocation of the API method. In some embodiments, the data structure may include the outputs generated by other destination devices 114. In some embodiments, the set of signals may be indicative of including, but not limited to, data packets, electrical signals, digital signals, radio signals, analog signals, infrared signals, and the like.

In some embodiments, the one or more pathways may be indicative of any constructed, decoupled or ephemeral pathway between the one or more source points and the destination endpoints that allow processing of data therebetween. In some embodiments, the one or more pathways may be indicative of communication protocols, such as those used by the network 112. In some embodiments, the one or more pathways generated by the pathway builder engine 110 may be implemented as a publisher-subscriber (pub-sub) model connection. The pub-sub model may allow the source points to publish one or more API methods and the destination endpoints to subscribe to the one or more API methods. The publisher-subscriber model may also allow the destination endpoints to receive the API methods and execute the one or more processor-executable instructions or routines or sub-routines associated with the API methods. In other embodiments, the one or more pathways generated by the pathway builder engine 110 may be implemented as a request-response model connection. The request-response model may allow the source points to send requests to the destination endpoints and the destination endpoints to receive the requests and send responses thereto.

Further, referring to FIG. 2A, the system 106 may include a plurality of pathway builders 110. As shown, the system 106 may include a meta connection builder that generates pathways within the system 106, an AI connection builder 110-2 for establishing pathways between system 106 and other autonomous agents, an App pathway builder 110-3 to generate pathways to one or more software applications deployed on external computing devices or virtual machines, a device connection builder 110-4 to generate pathways to one or more external computing devices, an IoT pathway builder 110-5 to generate pathways to one or more IoT devices, and an equipment pathway builder 110-6 to generate pathways to one or more industrial/commercial equipment. It may be appreciated by those skilled in the art that the system 106 may include additional pathway builders 110 to generate pathways to one or more destination endpoints of any device based on requirements. In some embodiments, the LM engine 108 may be embedded in the pathway builder engine 110, as shown in FIG. 2A, and in other embodiments, the LM engine 108 may be external to the pathway builder engine 110, as shown in FIG. 1.

Each of the pathway builder engine 110 may allow the system 106 to interact with one or more destination devices 114. In embodiments shown in FIG. 2A, a plurality of destination devices 114 may be coupled with each other in a mesh. A first subset of the plurality of destination devices 114 may form a private mesh 210, and a second subset of the plurality of destination devices 114 may form a public mesh 214. The destination devices 114 of the private mesh 210 may be associated with a network of destination devices 114 privately operated by one or more entities. Such destination devices 114 may be available for users having authorization from operators of said network. The destination devices 114 in the public mesh 214 may be associated with a plurality of destination devices 114 that may be publicly available. Such destination devices 114 may be accessible without authorization. Each slice in the private mesh 210, the public mesh 214 and the integrated mesh 212 may be indicative of each destination device 114. A third subset of the plurality of destination devices 114 may form an integrated mesh having one or more of both privately operated and public destination devices 114. In some embodiments, the private mesh 210, the integrated mesh 212 and the public mesh 214 may be compatible with each other to enable interactions therebetween.

In some embodiments, each of the plurality of destination devices 114 may be accessible using the one or more pathways. In an example, the system 106 may interact with the destination devices 114 via the one or more pathways. In other embodiments, each of each of the plurality of destination devices 114 may be accessible using any one or combination of including, but not limited to, Secure Shell (SSH), Remote Desktop Protocol (RDP), Virtual Network Computing (VNC), Hypertext Transfer Protocol (HTTP), Internet Control Message Protocol (ICMP), and other protocols. The system 106 may interact with the destination devices 114 using any one or combination of the inter-process communication means.

In some embodiments, the pathway builder engine 110 may generate one or more staging points associated with one or more intermediate processing engines (not shown) configured to transform the data transmitted via the one or more signals. In some embodiments, the one or more staging points may be configured to receive the one or more signals from the one or more source points, process the data and the one or more API methods in the one or more signals, and transmit the processed data and the one API methods to the destination endpoints for execution.

In some embodiments, once the LM engine 108 generates the one or more API methods and the pathway builders 110 generate the pathways to the one or more destination devices 114, the system 106 may generate the task flow indicating the one or more API methods to be invoked for each of the corresponding destination endpoints, and the sequence in which said API methods are to be invoked. The task flow may be displayed on the user interface 104 of the one or more user devices 102, the one or more API methods being editable via the user interface 104. The user interface 104, in such embodiments, may allow the user to manually accept or decline the execution of the one or more API methods. The user may also include one or more additional API methods to the task flow. In some embodiments, an interactive log of execution of API methods in destination devices 114 may be provided on the user interface 104. In some embodiments, notification of completion of the task or execution of individual API methods may be provided in the user interface 104.

In some embodiments, the system 106 may be configured to receive, from the one or more destination endpoints, a response having an output generated on execution of the one or more API methods in the corresponding destination devices. The system 106 may determine, using the LM engine 108, whether the output in the response corresponds to an expected output for the set of natural language instructions. In some embodiments, the system 106, by the LM engine 108, determines whether any one or more of interpretation of function from natural language input, grammar, vocabulary, colloquialisms, and semantics is extracted accurately.

In some embodiments, the system 106 may be configured to train the LM engine 108 with supervised and unsupervised machine learning techniques based on the response received from the destination endpoint. In some embodiments, the LM engine 108 may be fine-tuned based on whether the task was performed successfully. In some embodiments, the response may include one or more attributes associated with an execution environment of the destination devices 114 in which the one or more API methods are executed. In some embodiments, the execution environment may be a virtual environment, such as a software application. In such embodiments, the one or more attributes may correspond to one or more metadata attributes associated with the software application. In other embodiments, the execution environment may correspond to a physical environment. In such embodiments, the one or more attributes may correspond to location, temperature, weather conditions, health and performance metrics of the destination devices 114, and the like.

The one or more attributes may be received from a plurality of sources 202 such as modems 202-1, databases 202-2, sensors 202-3, internet 202-4, cloud databases 202-5, but not limited thereto. The system 106 may include an attribute aggregation engine 206 that aggregates the one or more attributes from the plurality of sources 202. The data collected from the plurality of sources 202 may be stored in a data lake. The attribute aggregation engine 206 may be coupled to the pathway builder engine 110 such that the one or more API methods are generated that allow the attribute aggregation engine 206 to collect data from the plurality of sources 202 by interacting with the one or more destination endpoints associated therewith. In such embodiments, the attribute aggregation engine 206 may autonomously collect data from the plurality of sources 202, thereby allowing for real-time collection of data from novel environments. In some embodiments, the LM engine 108 may be provided with a feedback during training by a heuristics engine 204 that generates said feedback by comparing the one or more attributes with a predefined set of heuristics, as shown in FIG. 2B. the predefined set of heuristics may be indicative of a state, search algorithm or a set of threshold values that allow the heuristic engine 204 to determine one or more evaluation metrics indicating including, but not limited to, health, performance, efficiency, and the like, of the one or more destination devices 114 or the API methods executed therein. The heuristics engine 204 may retrieve the one or more attributes from the data lake. In an example, the heuristics engine 204 may compare the temperature of the destination device 114 with a predefined threshold temperature and generate a feedback based on the comparison. Accordingly, the LM engine 108 may be trained to adjust the API method parameters based on the feedback received from the heuristics engine 204. In some embodiments, the heuristic engine 204 may be configured to update the predefined set of heuristics based on the feedback. With the LM engine 108 generating the one or more API methods and the heuristic engine 110 providing feedback based on the set of predefined heuristics, the system 106 may allow for development of bicameral agentic systems.

Therefore, the disclosed system 106 in network architecture 100 may allow for agentic AI. The system 106 may generate API methods for interacting with virtual and physical environments for performance of tasks provided in natural language by the users. The system 106 may make use of existing API methods or generate new API methods for the performance of the tasks for performing the tasks in novel situations. Allowing the system 106 to dynamically generate API methods based on one or more attributes associated with the environment allows for the system 106 to interact with the environment in an autonomous manner.

In an example, the system 106 may receive a set of natural language instructions to record data from one or more IoT sensors placed on a field that monitor movement of one or more cattle to controllably provide fodder to said cattle. The system 106 may receive instructions to provide fodder to a subset of cattle based on their movement using a fodder dispensing device, at predetermined intervals. In case existing API methods are insufficient to perform the task, the system 106 may generate one or more API methods and transmit a first API method to the one or more IoT devices for monitoring the movement of each of the cattle, a second API method to a staging point to determine the subset of cattle satisfying the one or more constraints, and a third API method to the fodder dispenser device to dispense fodder at predetermined intervals for the identified subset of cattle.

The system 106 may find applications in including, but not limited to, supply chain management, finance and operations, data and analytics, marketing and market functions, design, IT services, engineering and software development, retail, manufacturing, healthcare, transportation, logistics, food and beverage, energy and utilities, hospitality, education, government, and banking and financial services.

Although FIG. 1 shows exemplary components of the network architecture 100, in other embodiments, the network architecture 100 may include fewer components, different components, differently arranged components, or additional functional components than depicted in FIG. 1. Additionally, or alternatively, one or more components of the network architecture 100 may perform functions described as being performed by one or more other components of the network architecture 100.

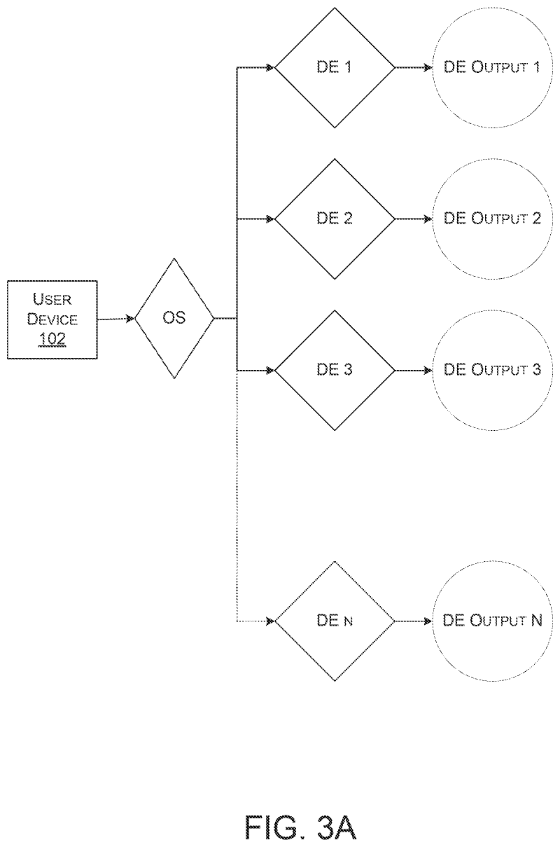

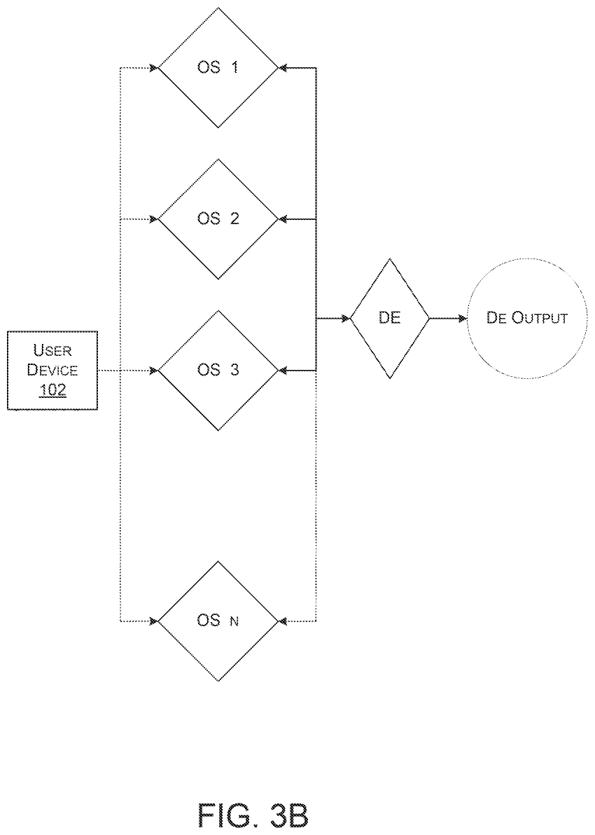

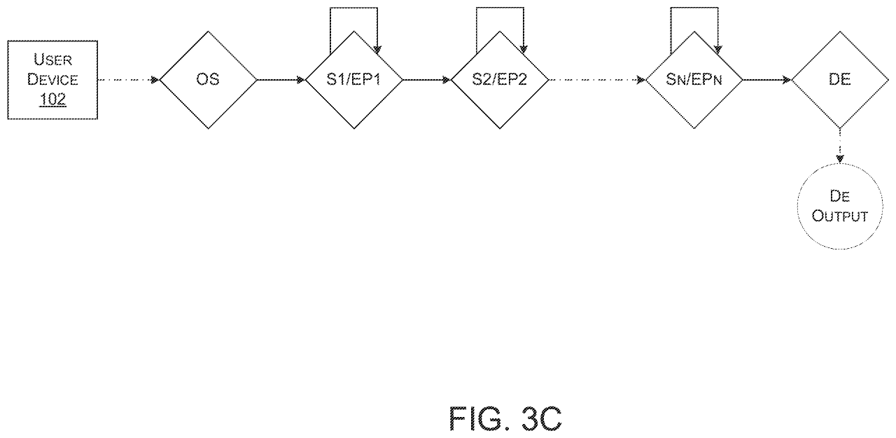

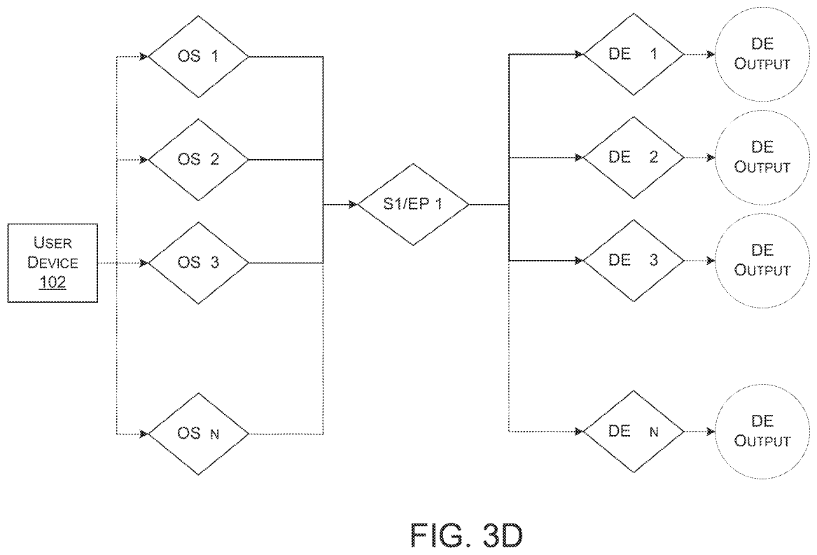

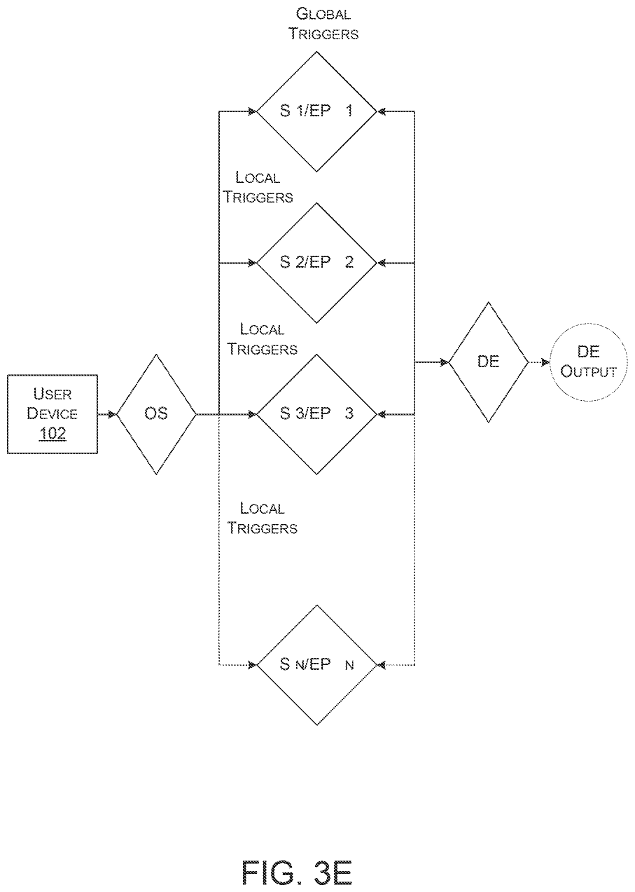

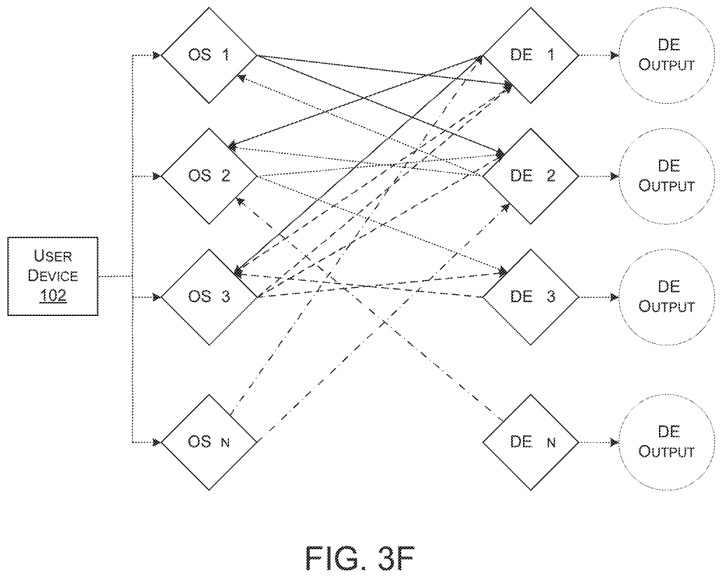

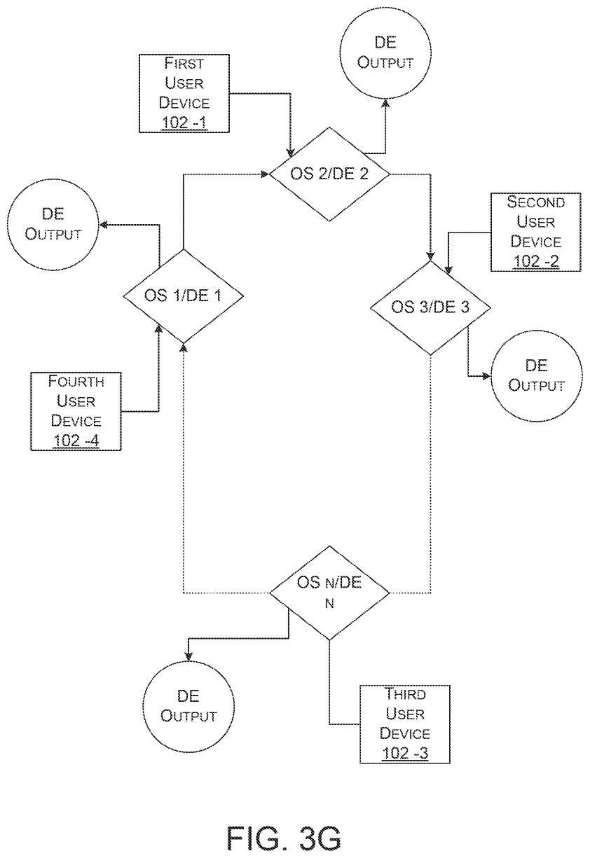

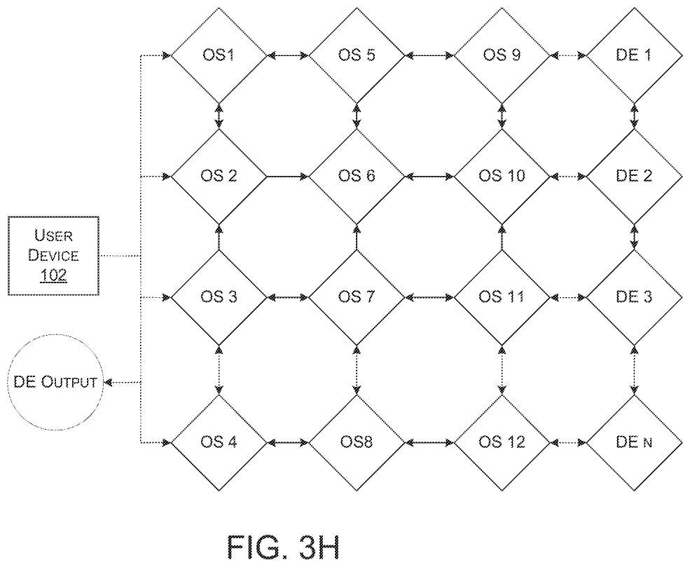

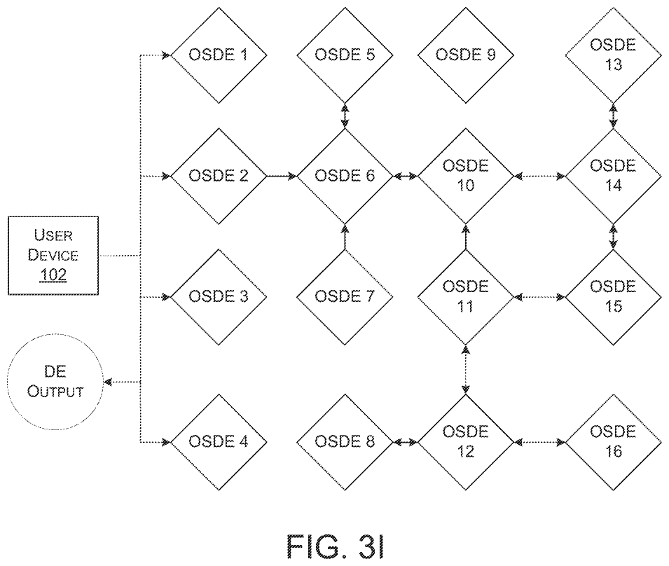

FIGS. 3A-3I illustrate exemplary implementations of the proposed system, in accordance with embodiments of the present disclosure. In some embodiments, each of the one or more source points and the one or more destination endpoints may be interconnected with each other by the one or more pathways such that said one or more source points receive and process the set of natural language instructions and transmit the set of signals to the one or more of the destination endpoints for executing the one or more API methods. The one or more of the sources points may be configured to receive the set of natural language instructions from any one or combination of the one or more user devices, the one or more source points, or the responses from one or more of the destination endpoints. In such embodiments, one or more of the destination endpoints may be configured to receive the set of signals from the one or more source points. Further, the one or more of the destination endpoints may be configured to execute the one or more API methods in the set of signals, and transmit the responses to one or more of the destination endpoints and the one or more source points. The one or more source points and the one or more destination endpoints may be interconnected in a plurality of combinations. FIGS. 3A to 3I illustrate a non-limiting set of interconnections between said source endpoints and the destination endpoints.

FIG. 3A illustrates an exemplary implementation where the pathway builder engine 110 generates pathways between one source point, such as source point OS, and a plurality of destination endpoints, such as destination endpoints DE 1, DE 2, DE 3, DE 4 . . . and DE N, each producing a corresponding response, such as DE output 1, DE output 2, DE output 3, DE output 4 . . . and DE output N respectively. In such implementations, a single source point may trigger a plurality of destination endpoints, each producing a corresponding response. In an example, the system 106 may receive a set of natural language instructions to a subroutine to generate data backups of data stored in a plurality of IoT devices. In such examples, the system 106 may be configured to generate the one or more API methods, and transmit said API methods for execution to a plurality of IoT devices for generating the data backups.

FIG. 3B illustrates an exemplary implementation where the pathway builder engine 110 generates pathways between a plurality of source points, such as source points OS 1, OS 2, OS 3, . . . and OS N, and one destination endpoint, such as destination endpoint DE. In such implementations, a plurality of source points may trigger a single destination endpoint, each producing a corresponding response. In an example, the system 106 may receive a set of natural language instructions to generate a visualization dashboard from data obtained from a plurality of source points. In such examples, the system 106 may be configured to generate one or more API methods, and transmit said one or more API methods from a plurality of source points for execution to a single destination device 114 such as a voting system.

FIG. 3C illustrates an exemplary implementation where the pathway builder engine 110 generates pathways with a single source point, such as source points OS, and a single destination endpoint, staging points S1/EP 1, S2/EP 2, S3/EP 3 . . . and SN/EPN. Each staging point can serve as both a source and an endpoint before loading the data to the next staging point. In some embodiments, the staging points may recursively execute the API methods until an end condition is satisfied. The API methods may trigger one or more of the plurality of staging points to transform the data in the data structure associated with the API method, and then provide the destination endpoint DE with the transformed data.

FIG. 3D illustrates an exemplary implementation where the pathway builder engine 110 generates pathways between a plurality of source points, such as source points OS 1, OS 2, OS 3, . . . and OS N, to a single staging point, such as staging point S1/EP1, and further to a plurality of destination endpoints, such as destination endpoints DE 1, DE 2, DE 3, . . . and DE N. In such implementations, multiple devices can query the staging point S1/EP1, allowing for dynamic referencing of inputs at the staging point for transforming the data in the one or more API methods, before being outputted to destination endpoints DE 1 to DE N. In an example, the staging point S1/EP1 may be configured to transform and publish data to the plurality of destination endpoints DE 1, DE 2, DE 3, . . . and DE N, when each of the plurality of source points OS 1, OS 2, OS 3, . . . and OS N transmit data to said staging point S1/EP1.

FIG. 3E illustrates an exemplary implementation where the pathway builder engine 110 generates pathways from a single source point, such as the source point OS, to a plurality of staging points, such as staging points SP1/EP1, SP2/EP2, SP3/EP3, . . . , SPN/EPN, and further to a single destination endpoint, such as destination endpoint DE. In this implementation, each staging point may perform transformations simultaneously or asynchronously based on triggers. The transformed data from each staging point is then directed to a single destination endpoint DE. The triggers and conditions for transformation at each staging point may be customized according to the specific requirements of the system 106.

FIG. 3F illustrates an exemplary implementation where the pathway builder engine 110 generates bi-directional pathways between a plurality of source points, such as source points OS 1, OS 2, OS 3, . . . , and OS N, and one or more destination endpoints, such as destination endpoints DE 1, DE 2, DE 3, . . . , and DE N. In such implementations, data processed by execution of the API method may flow in both directions between the source points and destination endpoints. The bidirectional interaction may allow for the exchange of information, transformations, and outputs between the source and destination endpoints based on requirements.

FIG. 3G illustrates an exemplary implementation where the pathway builder engine 110 generates one or more pathways between a plurality of source points and destination endpoints, wherein the source and the destination endpoints are implemented on a single destination device 114. The plurality of source points, such as OS 1, OS 2, OS 3, . . . , and OS N may be implemented with a corresponding destination endpoint DE 1, DE 2, DE 3, . . . , and DE N, such that the set of natural language instructions provided from a plurality of user devices, such as a first user device 102-1, a second user device 102-2, a third user device 102-3, and a fourth user device 102-4 are received by the OS1, OS2, OS3, . . . , and OSN, respectively, and processed by the destination endpoint DE1, DE2, DE3, . . . , and DEN, respectively, by execution of the one or more API methods to generate a corresponding DE output. In some embodiments, the DE output generated by execution of the one or more API methods destination endpoint DE1 may be transmitted as a signal to trigger the execution of the one or more API methods in the destination endpoint DE2 via the source point OS2, thereby allowing the destination endpoints DE1 and DE2 to interact with one another.

FIG. 3H illustrates an exemplary implementation where the system 106 includes a plurality of source points, such as OS 1 to OS 12, each source point being interconnected with each other by the pathway builder engine such that when the system 106 receives the set of natural language instructions from the one or more user devices 102, execution of each of the one or more API methods generated by the LM engine 108 triggers transmission and execution of the one or more API methods in each of the other source points. On triggering each of the source points, a chain of API methods may be triggered and/or executed in each of the source points to transform the data therein. Eventually, the plurality of source points triggers a plurality of destination endpoints, such as DE 1 to DE 4, that generate the DE output. The interconnected source points may incorporate the implementations described in FIG. 3A to FIG. 3G.

FIG. 3I illustrates an exemplary implementation where the system 106 includes a plurality of source points and destination endpoints implemented on a common destination device 114, such as OSDE 1 to 16. Each of the OSDEs may be interconnected to trigger a chain of other OSDEs to execute the one or more API methods generated by the LM engine 108. In some embodiments, the pathway builder engine 110 may generate ephemerally coupled pathways being each of the OSDEs such that the one or more pathways therebetween are generated and deleted based on satisfaction of one or more predefined constraints via the pathway builder engine. The pathway builder engine 110 may be configured to couple any two or more of the plurality of OSDEs based on the requirements. In some embodiments, the pathway builder engine 110 may be configured to combine one, few, or all of the information pathways described in FIGS. 3A to 3G, resulting in a distinct and new combination of one or more described information pathways. In an example, the pathway configuration can be represented as 1-1-1-N, indicating one source point, one staging point, one destination endpoint, and multiple other destination endpoints. Each endpoint in this configuration can possess the capabilities described by E(n) for event-driven interactions, T(n) for transformation capabilities, and L(n) for loading or transferring data.

By leveraging the flexibility and adaptability of the pathway builder engine 110, the system 106 is capable of dynamically creating an ephemeral mesh that optimizes the number and arrangement of source and destination endpoints based on user-defined constraints, resulting in a customized information pathway mesh that meets the specific requirements of the user.

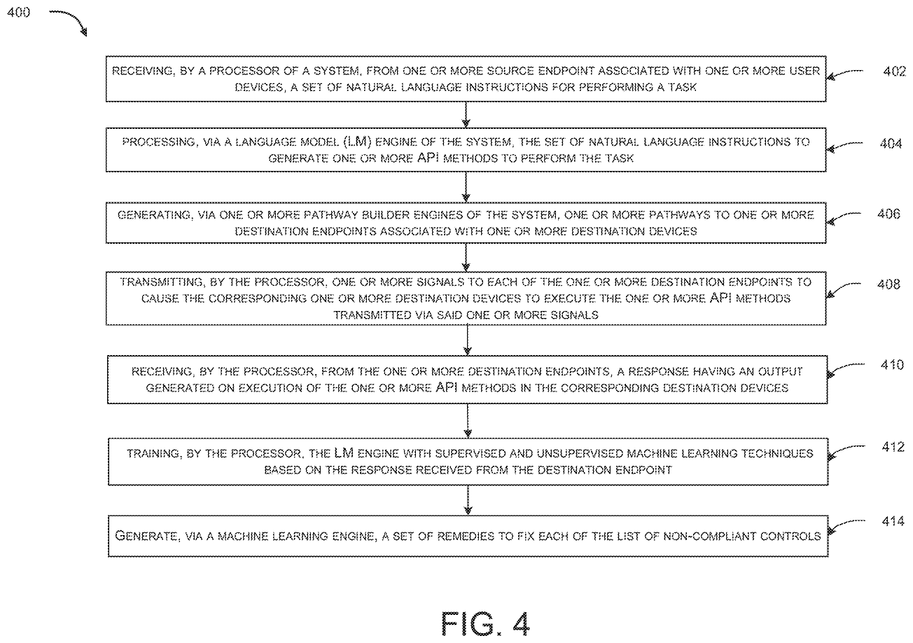

FIG. 4 illustrates an example flow chart of a method 400 dynamically generating application programming interface (API) methods for executing natural language instructions, in accordance with embodiments of the present disclosure. It may be appreciated that the method 400 may be performed by a system, as discussed herein. In an exemplary embodiment, the method 400 may be performed by a processor, such as processor 105 of FIG. 1, associated with or residing within the system 106.

Referring to FIG. 4, at block 402, the method 400 includes receiving, by the processor, from one or more source point associated with one or more user devices, a set of natural language instructions for performing a task.

At block 404, the method 400 includes processing, via a language model (LM) engine such as the LM engine 108 of FIG. 1, the set of natural language instructions to generate one or more API methods to perform the task.

At block 406, the method 400 includes generating, via one or more pathway builder engines such as the pathway builder 110 of FIG. 1, one or more pathways to one or more destination endpoints associated with one or more destination devices.

At block 408, the method 400 includes transmitting, by the processor, one or more signals to each of the one or more destination endpoints to cause the corresponding one or more destination devices to execute the one or more API methods transmitted via said one or more signals. The one or more signals may include the one or more API methods and a data structure having data required for execution of the one or more API methods.

At block 410, the method 400 includes receiving, by the processor, from the one or more destination endpoints, a response having an output generated on execution of the one or more API methods in the corresponding destination devices.

At block 412, the method 400 includes determining, by the processor, using the LM engine, whether the output in the response corresponds to an expected output for the set of natural language instructions. The LM engine may determine whether any one or more of interpretation of function from natural language input, grammar, vocabulary, colloquialisms, and semantics is extracted accurately.

At block 414, the method 400 includes training, by the processor, the LM engine with supervised and unsupervised machine learning techniques based on the response received from the destination endpoint. In some embodiments, the response may include one or more attributes associated with an execution environment of the one or more destination devices in which the one or more API methods are executed, and wherein the LM engine is provided with a feedback during training by a heuristics engine that generates said feedback by comparing the one or more attributes with a predefined set of heuristics. A person of ordinary skill in the art will readily ascertain that the illustrated blocks are set out to explain the exemplary embodiments shown, and it should be anticipated that ongoing technological development will change the manner in which particular functions are performed. These examples are presented herein for purposes of illustration, and not limitation. Further, the boundaries of the functional building blocks have been arbitrarily defined herein for the convenience of the description. Alternative boundaries can be defined so long as the specified functions and relationships thereof are appropriately performed. Alternatives (including equivalents, extensions, variations, deviations, etc., of those described herein) will be apparent to persons skilled in the relevant art(s) based on the teachings contained herein. Such alternatives fall within the scope of the disclosed embodiments.

### Exemplary Scenario

A User may provide natural language instruction, such as “How much did I spend on my credit cards this month?”, to the system 106 via the one or more user devices 103. The system 106, using the LM engine 108, may interpret the natural language instructions. In some examples, the LM engine 108 may extract named entities from the natural language instructions, and returns a dictionary of the extracted entities. Thereafter, the LM engine 108 may identify intent in the command. The LM engine 108 may map the intent and the extracted entities with one or more APIs methods in the API repository. The API repository may define two API methods along with their required parameters, viz. a credit_card_spending API expecting a ‘credit_card’ parameter and a ‘month’ parameter, and a bank_balance API expecting a ‘bank_account’ parameter. Each of the API methods further include a destination endpoint, indicative of a URL to which the API call must be made. In examples where an API method is mapped successfully to the extracted entities and the intent, the system 106 may transmit a set of signals to the destination endpoints to execute said API method. In examples where an API method is unmappable with the extracted entities and the identified intent, the LM engine 108 may generate one or more API methods with corresponding destination endpoint and a set of parameters for execution of the identified intent/task in the natural language instruction. The system 106 may then transmit the set of signals to execute the constructed API method. The destination device 114 may execute a routine or a subroutine for one receiving the API method. The system 106 may then receive a response from the destination endpoint, the response having an output. The response may be parsed, processed, and displayed to the user on the user interface 104.

Therefore, in accordance with embodiments of the present disclosure, the disclosed solution may provide for an agentic AI capable of dynamically generating one or more API methods to interact and respond to novel environments. The system of the present disclosure may also be capable of learning from past interactions, thereby being able to adapt and respond to changing environments, and allow for enabling development of bicameral agentic systems.

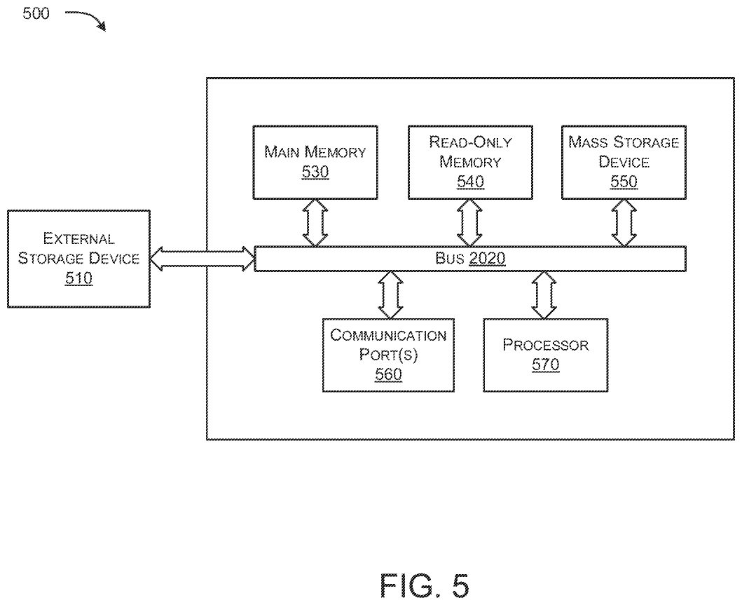

FIG. 5 illustrates a computer system 500 in which or with which embodiments of the present disclosure may be implemented. In particular, the disclosed system, i.e. the system may be implemented as the computer system 500.

Referring to FIG. 5, the computer system 500 may include an external storage device 510, a bus 520, a main memory 530, a read-only memory 540, a mass storage device 550, communication port(s) 560, and a processor 570. A person skilled in the art will appreciate that the computer system 500 may include more than one processor and communication ports. The communication port(s) 560 may be any of an RS-232 port for use with a modem-based dialup connection, a 10/100 Ethernet port, a Gigabit or 10 Gigabit port using copper or fiber, a serial port, a parallel port, or other existing or future ports. The communication port(s) 560 may be chosen depending on a network, such a Local Area Network (LAN), Wide Area Network (WAN), or any network to which the computer system 500 connects. The main memory 530 may be random access memory (RAM), or any other dynamic storage device commonly known in the art. The read-only memory 540 may be any static storage device(s) including, but not limited to, a Programmable Read Only Memory (PROM) chips for storing static information e.g., start-up or basic input/output system (BIOS) instructions for the processor 570. The mass storage device 550 may be any current or future mass storage solution, which may be used to store information and/or instructions. The bus 520 communicatively couples the processor 570 with the other memory, storage, and communication blocks. The bus 520 can be, e.g. a Peripheral Component Interconnect (PCI)/PCI Extended (PCI-X) bus, Small Computer System Interface (SCSI), universal serial bus (USB), or the like, for connecting expansion cards, drives, and other subsystems as well as other buses, such a front side bus (FSB), which connects the processor 570 to the computer system 500. Optionally, operator and administrative interfaces, e.g. a display, keyboard, and a cursor control device, may also be coupled to the bus 520 to support direct operator interaction with the computer system 500. Other operator and administrative interfaces may be provided through network connections connected through the communication port(s) 560. In no way should the aforementioned exemplary computer system limit the scope of the present disclosure.

One of ordinary skill in the art will appreciate that techniques consistent with the present disclosure are applicable in other contexts as well without departing from the scope of the disclosure.

What has been described and illustrated herein are examples of the present disclosure. The terms, descriptions, and figures used herein are set forth by way of illustration only and are not meant as limitations. Many variations are possible within the scope of the subject matter, which is intended to be defined by the following claims and their equivalents in which all terms are meant in their broadest reasonable sense unless otherwise indicated.

1. A system, comprising:
a processor; and
a memory operatively coupled with the processor, wherein the memory comprises processor-executable instructions which, when executed by the processor, cause the processor to:
receive, from one or more source point associated with one or more user devices, a set of natural language instructions for performing a task;
process, via a language model (LM) engine, the set of natural language instructions to generate one or more application programming interface (API) methods to perform the task;
generate, via one or more pathway builder engines, one or more pathways to one or more destination endpoints associated with one or more destination devices; and
transmit one or more signals to each of the one or more destination endpoints to cause the corresponding one or more destination devices to execute the one or more API methods transmitted via said one or more signals, wherein the one or more signals comprises the one or more API methods and a data structure having data required for execution of said one or more API methods.

2. The system of claim 1, wherein the processor is configured to:
receive, from the one or more destination endpoints, a response having an output generated on execution of the one or more API methods in the corresponding destination devices; and
determine, using the LM engine, whether the output in the response corresponds to an expected output for the set of natural language instructions.

3. The system of claim 2, wherein the processor is configured to:
train the LM engine with supervised and unsupervised machine learning techniques based on the response received from the destination endpoint, wherein the response comprises one or more attributes associated with an execution environment of the one or more destination devices in which the one or more API methods are executed, and wherein the LM engine is provided with a feedback during training by a heuristics engine that generates said feedback by comparing the one or more attributes with a predefined set of heuristics.

4. The system of claim 1, wherein the one or more destination devices is selected from a group comprising a software application on a computing device, a virtual machine, Internet of Things (IoT) device, autonomous robots, and industrial/commercial equipment.

5. The system of claim 1, wherein the one or more API methods are displayed on the user interface of the one or more user device, the one or more API methods being editable via the user interface.

6. The system of claim 1, wherein the processor is to:
generate, via the pathway builder engine, one or more staging points associated with one or more intermediate processing engines configured to transform the data transmitted via the one or more signals, wherein the one or more staging points configured to receive the one or more signals from the one or more source points, process the data and the one or more API methods in the one or more signals, and transmit the processed data and the one API methods to the destination endpoints for execution.

7. The system of claim 1, wherein the one or more API methods are either generated by the LM engine in real-time based on the set of natural language instructions, or retrieved from an API repository based on the set of natural language instructions, the API repository being periodically updated.

8. The system of claim 1, wherein each of the one or more source points and the one or more destination endpoints are interconnected with each other by the one or more pathways such that said one or more source points receive and process the set of natural language instructions and transmit the set of signals to the one or more of the destination endpoints for executing the one or more API methods, wherein said one or more of the sources points is configured to receive the set of natural language instructions from any one or combination of:
the one or more user devices, the one or more source points, or the responses from one or more of the destination endpoints;
wherein one or more of the destination endpoints are configured to receive the set of signals from the one or more source points, said one or more of the destination endpoints being configured to execute the one or more API methods in the set of signals, and transmit the responses to one or more of the destination endpoints and the one or more source points.

9. The system of claim 1, wherein the one or more pathways are ephemerally coupled such that the one or more pathways between the one or more source points and the one or more destination endpoints are generated and deleted based on satisfaction of one or more predefined constraints via the pathway builder engine.

10. A computer-implemented method, comprising:
receiving, by a processor of a system, from one or more source point associated with a user device of a user, a set of natural language instructions for performing a task;
processing, via a language model (LM) engine of the system, the set of natural language instructions to generate one or more API methods to perform the task;
generating, via one or more pathway builder engines of the system, one or more pathways to one or more destination endpoints associated with one or more destination devices; and
transmitting, by the processor, one or more signals to each of the one or more destination endpoints to cause the corresponding one or more destination devices to execute the one or more API methods transmitted via said one or more signals, wherein the one or more signals comprises the one or more API methods and a data structure having data required for execution of the one or more API methods.

11. The computer-implemented method of claim 10, further comprising:
receiving, by the processor, from the one or more destination endpoints, a response having an output generated on execution of the one or more API methods in the corresponding destination devices; and
determining, by the processor, using the LM engine, whether the output in the response corresponds to an expected output for the set of natural language instructions.

12. The computer-implemented method of claim 11, further comprising:
training, by the processor, the LM engine with supervised and unsupervised machine learning techniques based on the response received from the destination endpoint, wherein the response comprises one or more attributes associated with an execution environment of the one or more destination devices in which the one or more API methods are executed, and wherein the LM engine is provided with a feedback during training by a heuristics engine that generates said feedback by comparing the one or more attributes with a predefined set of heuristics.

13. The computer-implemented method of claim 10, wherein the one or more destination devices is selected from a group comprising a software application on a computing device, a virtual machine, Internet of Things (IoT) device, autonomous robots, and industrial/commercial equipment.

14. The computer-implemented method of claim 10, wherein the one or more API methods are displayed on a user interface of the user device, the one or more API methods being editable via the user interface.

15. The computer-implemented method of claim 10, further comprising:
generating, via the pathway builder engine, one or more staging points associated with one or more intermediate processing engines configured to transform the data transmitted via the one or more signals, wherein the one or more staging points to configured to receive the one or more signals from the one or more source points, process the data and the one or more API methods in the one or more signals, and transmit the processed data and the one API methods to the destination endpoints for execution.

16. The computer-implemented method of claim 10, wherein the one or more API methods are either generated by the LM engine in real-time based on the set of natural language instructions, or retrieved from an API repository based on the set of natural language instructions, the API repository being periodically updated.

17. The computer-implemented method of claim 10, wherein each of the one or more source points and the one or more destination endpoints are interconnected with each other by the one or more pathways such that said one or more source points receive and process the set of natural language instructions and transmit the set of signals to the one or more of the destination endpoints for executing the one or more API methods, wherein said one or more of the sources points is configured to receive the set of natural language instructions from any one or combination of:
the one or more user devices, the one or more source points, or the responses from one or more of the destination endpoints;
wherein one or more of the destination endpoints are configured to receive the set of signals from the one or more source points, said one or more of the destination endpoints being configured to execute the one or more API methods in the set of signals, and transmit the responses to one or more of the destination endpoints and the one or more source points.

18. The computer-implemented of claim 10, wherein the one or more pathways are ephemerally coupled such that the one or more pathways between the one or more source points and the one or more destination endpoints are generated and deleted based on satisfaction of one or more predefined constraints via the pathway builder engine.

19. A non-transitory computer-readable medium comprising processor-executable instructions that cause a processor to:
receive, from one or more source point associated with a user device of a user, a set of natural language instructions for performing a task;
process, via a language model (LM) engine, the set of natural language instructions to generate one or more API methods to perform the task;
generate, via one or more pathway builder engines, one or more pathways to one or more destination endpoints associated with one or more destination devices; and
transmit one or more signals to each of the one or more destination endpoints to cause the corresponding one or more destination devices to execute the one or more API methods transmitted via said one or more signals, wherein the one or more signals comprises the one or more API methods and a data structure having data required for execution of the one or more API methods.
